(19) United States
(12) Patent Application Publication
(10) Pub. No.: US 2023/0217362 A1
(43) Pub. Date: Jul. 6, 2023

(54) FIRST NODE, SECOND NODE, AND METHODS PERFORMED THEREBY, FOR HANDLING SCALING OF A NETWORK SLICE IN A COMMUNICATIONS NETWORK

(71) Applicant: Telefonaktiebolaget LM Ericsson (publ), Stockholm (SE)

(72) Inventors: Nipun SHARMA, New Delhi (IN); Rakesh BAJPAI, New Delhi (IN); Steve MENEAR, Hiram, GA (US); Tushar SABHARWAL, New Delhi (IN); Hans ERIKSSON, Sollentuna (SE); Rajiv BHARDWAJ, Jalandhar (IN)

(73) Assignee: Telefonaktiebolaget LM Ericsson (publ), Stockholm (SE)

(21) Appl. No.: 17/763,829

(22) PCT Filed: Sep. 25, 2019
(86) PCT No.: PCT/SE2019/050916

§ 371 Date: Mar. 25, 2022

(51) Int. Cl. H04W 48/18; H04W 16/10

(52) U.S. Cl. CPC H04W 48/18; H04W 16/10

(57) ABSTRACT

A method, performed by a first node (111). The method is for handling scaling of a network slice in a communications network (100). The first node (111) operates in the communications network (100). The first node (111) obtains (203), from a second node (112) operating in the communications network (100), a request to scale a network slice. The first node (111) then determines (204) whether or not to scale the network slice. The determining (204) is based on a cost effectiveness of the network slice.

### CROSS-REFERENCE TO RELATED APPLICATIONS

This application is a 35 U.S.C. § 371 National Stage of International Patent Application No. PCT/SE2019/050916, filed Sep. 25, 2019.

### TECHNICAL FIELD

The present disclosure relates generally to a first node and methods performed thereby for handling scaling of a network slice in a communications network. The present disclosure also relates generally to a second node, and methods performed thereby for handling scaling of a network slice in a communications network. The present disclosure also relates generally to computer programs and computer-readable storage mediums, having stored thereon the computer programs to carry out these methods.

### BACKGROUND

Communication devices within a telecommunications network may be user equipments (UEs), e.g., stations (STAs), wireless devices, mobile terminals, wireless terminals, terminals, and/or Mobile Stations (MS). User equipments are enabled to communicate wirelessly in a cellular communications network or wireless communication network, sometimes also referred to as a cellular radio system, cellular system, or cellular network. The communication may be performed e.g., between two user equipments, between a user equipment and a regular telephone, and/or between a user equipment and a server via a Radio Access Network (RAN), and possibly one or more core networks, comprised within the telecommunications network. User equipments may further be referred to as mobile telephones, cellular telephones, laptops, or tablets with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another terminal or a server.

The telecommunications network may cover a geographical area which may be divided into cell areas, each cell area being served by a network node, e.g., a radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

In 3rd Generation Partnership Project (3GPP) Long Term Evolution (LTE), base stations, which may be referred to as eNodeBs or even eNBs, may be directly connected to one or more core networks. All data transmission in LTE is controlled by the radio base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

Network Slicing

In the 5G architecture, the concept of network slicing has been introduced, which may be understood as “a set of network functions, and resources to run these network functions, forming a complete instantiated logical network to meet certain network characteristics required by the Service Instance(s).” An instantiated logical network may be understood as a dedicated set of instantiated network resources, software and hardware, that may be understood to form a complete network configuration isolated from other logical network instances, for a set of user terminals authorized to be connected to the logical network instance, that is, a network slice instance.

Network slicing may be understood to primarily comprise the following components: physical resource, logical resource, and network function.

Physical resource may be understood as a physical asset capable of performing computation, storage or transport including radio access. Logical resource may be understood as a partition of a physical resource, or grouping of multiple physical resources dedicated to a Network Function or shared between a set of Network Functions. A Network Function (NF) may be understood to refer to processing functions executing a dedicated task in a network. This may include, but is not limited to, telecom nodes functionality, as well as switching functions e.g., Ethernet switching function, and Internet Protocol (IP) routing functions. A Virtual Network Function (VNF) may be understood as a virtualized version of a NF. Further details on VNF may be found in the European Telecommunication Standards Institute (EISI) NFV. Network Functions are not regarded as resources.

A network slice may be defined within a Public Land Mobile Network (PLMN) and may be understood to include a Core Network Control Plane and User Plane Network Functions, and, in the serving PLMN, at least one of the following: the NG Radio Access Network and the N3IWF functions to the non-3GPP Access Network.

In the home network, the PLMN Operator may manage and orchestrate the Network Slicing operations for the 5G subscribers. These slicing operations may include design, instantiate, operate and decommission network slice s for the 5G subscribers.

In the past, there was no network slice or network slice Selection Assistance Information (NSSAI). NSSAI may be understood as information that a 5G radio access network (RAN) may use to select a sub-network slice instance in the 5G core network. Each NSSAI may comprise a number of sub network instances allowing a UE to be connected to more than one sub-network slice in the Core network at the same time. With 5G, there may be an option to create different network slice s for different requirements. The PLMN may combine different 5G core network (5GC) elements to deliver more flexible type of network slices or Network Slice Selection Assistance Informations (NSSAIs), and these network slices may be delivered in real time based on Single Network Slice Selection Assistance Information (S-NSSAI) values provided in the N1 interface, that is, the interface between a UE and the 5GC (5G Core network) Access Management Function (AMF).

The 5GC may be understood to be responsible for selection of a network slice instance(s) to serve a UE and the 5GC Control Plane and user plane Network Functions corresponding to the network slice instance.

These network slice s may be scaled dynamically based on the requirement of the subscriber which may be connected to that slice. To scale a network slice may be understood as adding or reducing network resources to a network slice instance. For example, more compute and memory capacity may be added to a VNF instance or additional VNF instances of same type may be instantiated to extend the capacity of a network slice. A network slice instance may comprise one or several different types of VNFs and the network slice instance may be scaled by scaling individual VNFs differently.

VNF instance scaling may often be understood to be the result of a service quality threshold being crossed—whether because service quality may no longer be acceptable, requiring expanding capacity, or because service quality and utilization may be such that capacity may be contracted without affecting quality delivered.

The scaling use cases may be grouped in three categories:

(1) Auto-scaling, in which a VNF Manager (VNFM) may monitor the state of a VNF instance and trigger the scaling operation when certain conditions are met. For monitoring a state of a VNF instance, the VNF manager may for instance track infrastructure-level and/or VNF-level events, where an event may be understood as an internal measure inside the VNF on e.g., incoming message bussers have increased above a threshold value, indicating that there may be risk for internal congestion in the VNF instance. Infrastructure-level events may be generated by a Virtualized Infrastructure Manager (VIM). VNF-Level events may be generated by the VNF instance or its Element Manager (EM).
(2) On-demand scaling, in which a VNF instance, or its EM, may monitor the state of a VNF instance and trigger a scaling operation through explicit request to the VNF Manager(
(3) Scaling based on a management request, where the scaling request may be triggered by a sender, such as an Operation Support System node (OSS)/Business support system (BSS) or an operator, towards VNFM via a Network Virtualization Function Orchestrator (NFVO).

In case there is requirement to increase the resources for a slice, this may be decided based on the available physical and/or logical resources under the Virtualized Infrastructure Manager (VIM), and may be understood to be static in nature. That is, a VIM may be understood to have a static long term stable allocation of hardware resources CPU, memory and disk in a cloud infrastructure which may be used for the VNFs, in regards to how much of the hardware resources may be consumed. Such static scaling may result in network resources being wasted and/or in heavier costs of the resources in the operation of the network. This may be the case, for example, if a peak allocation is done for all VNF types that may be running in same VIM.

### SUMMARY

It is an object of embodiments herein to improve the handling of scaling of a network slice in a communications network.

According to a first aspect of embodiments herein, the object is achieved by a method, performed by a first node. The method is for handling scaling of a network slice in a communications network. The first node operates in the communications network. The first node obtains, from a second node operating in the communications network, a request to scale a network slice. The first node also determines whether or not to scale the network slice. The determining is based on a cost effectiveness of the network slice.

According to a second aspect of embodiments herein, the object is achieved by a method, performed by the second node. The method is for handling the scaling of the network slice in the communications network. The second node operates in the communications network. The second node obtains, from a third node operating in the communications network, a request to scale the network slice. The second node determines whether or not to forward the request to the first node operating in the communications network. The determining is based on an amount of available resources in the communications network to scale the network slice being below a first threshold. The second node then forwards the request to the first node, based on a result of the determining.

According to a third aspect of embodiments herein, the object is achieved by the first node, for handling scaling of the network slice in the communications network. The first node is configured to operate in the communications network. The first node is further configured to obtain, from the second node configured to operate in the communications network, the request to scale the network slice. The first node is also configured to determine whether or not to scale the network slice. To determine is configured to be based on the cost effectiveness of the network slice.

According to a fourth aspect of embodiments herein, the object is achieved by the second node, for handling scaling of the network slice in the communications network. The second node is configured to operate in the communications network. The second node is further configured to obtain, from the third node configured to operate in the communications network, the request to scale the network slice. The second node is further configured to determine whether or not to forward the request to the first node configured to operate in the communications network. To determine is configured to be based on the amount of available resources in the communications network to scale the network slice being below the threshold. The second node is also configured to forward the request to the first node, based on a result of the determining.

According to a fifth aspect of embodiments herein, the object is achieved by a computer program, comprising instructions which, when executed on at least one processor, cause the at least one processor to carry out the method performed by the first node.

According to a sixth aspect of embodiments herein, the object is achieved by a computer-readable storage medium, having stored thereon the computer program, comprising instructions which, when executed on at least one processor, cause the at least one processor to carry out the method performed by the first node.

According to an seventh aspect of embodiments herein, the object is achieved by a computer program, comprising instructions which, when executed on at least one processor, cause the at least one processor to carry out the method performed by the second node.

According to an eighth aspect of embodiments herein, the object is achieved by a computer-readable storage medium, having stored thereon the computer program, comprising instructions which, when executed on at least one processor, cause the at least one processor to carry out the method performed by the second node.

By the first node determining whether or not to scale the network slice based on the cost effectiveness of the network slice, the first node is enabled make a decision, prioritizing, for example, a network slice having higher cost effectiveness, rather than treating all slices in the same way. An advantage of this prioritization may be that the network resources may then be managed more efficiently, as for example, more users may be provided with services based on network slices. Another advantage of this prioritization may be that the proportion of operating costs of the network can be managed more efficiently, avoiding an unnecessary increase in the proportion of operating costs due to a static management of network slice scaling requests, or a static prioritization of network slice scaling requests, while still delivering the same or better services to customers.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications network, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a schematic diagram depicting a non-limiting example of an architecture of a communications network, according to embodiments herein.

FIG. 5 is a schematic diagram depicting a non-limiting example of signalling between nodes in a communications network, according to embodiments herein.

FIG. 6 is a schematic diagram depicting a non-limiting example of signalling between nodes in a communications network, according to embodiments herein.

FIG. 7 is a schematic diagram depicting a non-limiting example of signalling between nodes in a communications network, according to embodiments herein.

FIG. 8 is a schematic diagram depicting a non-limiting example of signalling between nodes in a communications network, according to embodiments herein.

FIG. 9 is a schematic diagram depicting a non-limiting example of signalling between nodes in a communications network, according to embodiments herein.

FIG. 10 is a schematic diagram depicting a non-limiting example of signalling between nodes in a communications network, according to embodiments herein.

FIG. 11 is a schematic diagram depicting a non-limiting example of signalling between nodes in a communications network, according to embodiments herein.

FIG. 12 is a schematic block diagram illustrating two non-limiting examples, a) and b), of a first node, according to embodiments herein.

FIG. 13 is a schematic block diagram illustrating two non-limiting examples, a) and b), of a second node, according to embodiments herein.

### DETAILED DESCRIPTION

As part of the development of embodiments herein, a problem with existing methods will first be identified and discussed.

In case of resource scarcity and using existing methods, the network may be unable to provide required resources for all slices. For example, in the particular case of slice scaling, the network may be unable to provide all the scaling requests if the available resources are limited. Currently, network slice scaling is done without considering any priority between different slices. Network slice scaling is currently controlled only based on static resource allocation, whereby the same priority is provided to all the slices, which means the dynamic nature of the network, where conditions may change is not considered.

Each network slice has accompanying cost in terms of the resources used. The Communication Service Provider (CSP) may incur a cost for each resource which may be used by the network slice. This resource may be a) physical, such as e.g., servers and IP infrastructure etc., b) logical, such as e.g., bandwidth used from an Internet Service Provider (ISP), electricity used for power & air conditioning etc., and/or c) application based, such as e.g., 3PP, or own licenses etc. In existing methods, any request for VNF scaling is currently considered with equal priority, without considering cost aspects. Further particularly, when scaling different slices, network slice revenue and cost are not considered for prioritization when considering expansion of a network function (NF) to respective network slices, that is, in consideration of the cost effectiveness of the respective network slices. In case of resource scarcity and using existing methods, a slice which has a low cost effectiveness may get the resources for expansion, while another slice which has a high cost effectiveness may fail to expand. This does not ensure the best use of resources to maximize the cost effectiveness, especially in case of congestion time, which is quite frequent in telecommunication networks, especially around special days, events, etc. . . . . All the flexibility and dynamic options provided by network slice may therefore result in low cost effectiveness for the network. For example: two network slices (NS1, NS2) may be first initiated with a total of 40 network functions each, with a cost incurred of 20K USD and revenue of 30K USD. Later, a request to scale up the first slice NS1 may be received, wherein the NF may be requested to be further increased to 60 network functions, with a new cost incurred of 30K USD and a revenue increase of e.g., 31K USD, because of e.g., low usage by the subscribers. If at the same time, another request to scale up the second slice NS2 is received, having cost of 30K USD and a revenue increase of e.g., 40K USD, if the network is unable to comply with both requests due to resource scarcity, the proportional cost of the resources to scale up one of the slices is significantly higher if the first request is granted rather than the second request, over the whole operation due to potential loss of revenues for the NS2 if there are not enough resources available.

Embodiments herein may be understood to address this problem by providing a new functionality for network slicing for 5G networks, comprising methods and procedures to prioritize a network slice. The network slice scaling, e.g., expansion, use case is considered in embodiments herein to explain slice prioritization, wherein a network slice may be prioritized as per the cost effectiveness of that slice.

Each network slice has accompanying cost in terms of the resources used and revenue in terms of slice revenue. These factors are considered in embodiments herein, while allocating resources to different network slices, especially in congestion time, when the load of the network may be high. By considering the real time cost generated by each slice, including revenue, cost of infrastructure and other resources for network slices, a network slice prioritization may be achieved. In case of slice congestion and an expansion requirement, the priority to resource access may be based on cost effectiveness associated with the network slice. Embodiments herein may therefore be understood to be related to methods to decide a network slice priority based on the cost of the network slice, factoring in revenue information, that is, based on the cost effectiveness of the network slice.

The embodiments will now be described more fully hereinafter with reference to the accompanying drawings, in which examples are shown. In this section, embodiments herein are illustrated by exemplary embodiments. It should be noted that these embodiments are not mutually exclusive. All possible combinations are not described to simplify the description. Components from one embodiment or example may be tacitly assumed to be present in another embodiment or example and it will be obvious to a person skilled in the art how those components may be used in the other exemplary embodiments.

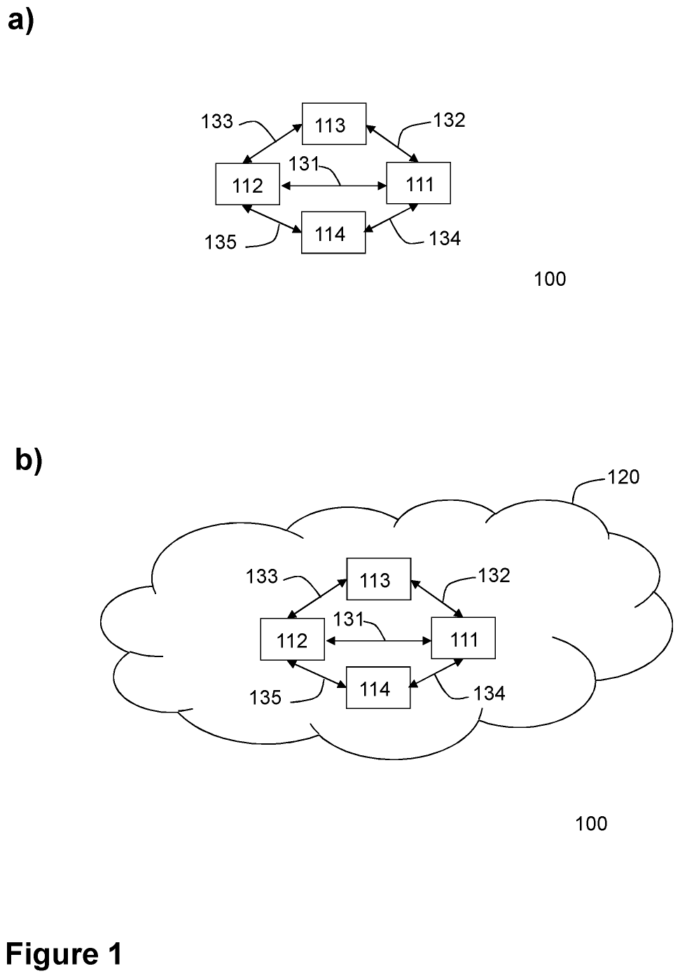

FIG. 1 depicts two non-limiting examples, in panels “a” and “b”, respectively, of a communications network 100, in which embodiments herein may be implemented. The communications network 100 may be a cellular radio system, cellular network or wireless communications system. In some examples, the telecommunications network may comprise network nodes which may serve receiving nodes, such as wireless devices, with serving beams.

The communications network 100 may for example be a network such as 5G system, or Next Gen network, or a newer system supporting similar functionality. The communications network 100 may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

The communications network 100 may comprise a plurality of nodes, whereof a first node 111, a second node 112, a third node 113, and one or more fourth nodes 114 are depicted in FIG. 1. Any of the first node 111, the second node 112, the third node 113, and the one or more fourth nodes 114 may be understood, respectively, as a first computer system, a second computer system, a third computer system, and one or more fourth computer systems, as depicted in the non-limiting example of FIG. 1a). In some examples, any of the first node 111, the second node 112, the third node 113, and the one or more fourth nodes 114 may be implemented as a standalone server in e.g., a host computer in the cloud 120, as depicted in the non-limiting example of FIG. 1b). Any of the first node 111, the second node 112, the third node 113, and the one or more fourth nodes 114 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, and the one or more fourth nodes 114 may also be implemented as processing resources in a server farm.

In some embodiments, any of the first node 111, the second node 112, the third node 113, and the one or more fourth nodes 114 may be independent and separated nodes. In other embodiments, any of the first node 111, the second node 112, the third node 113, and the one or more fourth nodes 114 may be co-located, or be the same node.

All the possible combinations are not depicted in FIG. 1 to simplify the Figure. In some examples of embodiments herein, the first node 111 may be a Data Analytics Function (DAF), e.g., in 5G, or a node capable of performing a similar function in the communications network 100. The DAF node may be understood to be an analytics node introduced in 5G which may support Automation and Analytics as they may be needed for the 5G architecture to be agile, and dynamic in terms of scale out and/or scale in based on dynamic network conditions. The second node 112 may be a Network Virtualization Function Orchestrator (NFVO), e.g., in 5G, or a node capable of performing a similar function in the communications network 100. The third node 113 may be a Virtual Network Function (VNF), or a node capable of performing a similar function in the communications network 100. Any of the one or more fourth nodes 114 may be another node in the communications network 100, such as, for example, any of a Business support system (BSS)/Data warehouse, a Provisioning node, or an Operation Support System node (OSS)/Provisioning node, the NFVO, or a node capable of performing a similar functions to any of these respective nodes in the communications network 100. The Provisioning node may be Network Slice Manager (NSM), which may be external to a NFV Architectural Framework.

The communications network 100 may, in some examples, comprise one or more radio network nodes, which are not depicted in FIG. 1. Each of the one or more radio network nodes may typically be a base station or Transmission Point (TP), or any other network unit capable to serve a wireless device or a machine type node in the communications network 100. Any of the one or more radio network nodes may be e.g., a 5G gNB, a 4G eNB, or a radio network node in an alternative 5G radio access technology, e.g., fixed or WiFi. Any of the one or more radio network nodes may be e.g., a Wide Area Base Station, Medium Range Base Station, Local Area Base Station and Home Base Station, based on transmission power and thereby also coverage size. Any of the one or more radio network nodes may be a stationary relay node or a mobile relay node. Any of the one or more radio network nodes may support one or several communication technologies, and its name may depend on the technology and terminology used. Any of the one or more radio network nodes may be directly connected to one or more networks and/or one or more core networks.

The communications network 100 may cover a geographical area which may be divided into cell areas, wherein each cell area may be served by a radio network node, although, one radio network node may serve one or several cells.

The communications network 100 may, in some examples, comprise a user equipment, or more, which are not depicted either in FIG. 1. The user equipment may be also known as e.g., a wireless device, mobile terminal, wireless terminal and/or mobile station, mobile telephone, cellular telephone, or laptop with wireless capability, or a Customer Premises Equipment (CPE), just to mention some further examples. The user equipment in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications network 100. The user equipment may be wireless, i.e., it may be enabled to communicate wirelessly in the communications network 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications network 100.

The first node 111 may communicate with the second node 112 over a respective first link 131, e.g., a radio link or a wired link. The first node 111 may communicate with the third node 113 over a second link 132, e.g., a radio link or a wired link. The third node 113 may communicate with the second node 112 over a third link 133, e.g., a radio link or a wired link. Any of the one or more fourth nodes 114 may communicate with the first node 111 over a respective fourth link 134, e.g., a radio link or a wired link. Any of the one or more fourth nodes 114 may communicate with the second node 112 over a respective fifth link 145, e.g., a radio link. Any of the first link 131, the second link 132, the third link 133, the fourth link 134 or the fifth link 165, may be a direct link or it may go via one or more computer systems or one or more core networks in the communications network 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third”, “fourth”, and/or “fifth” herein may be understood to be an arbitrary way to denote different elements or entities, and may be understood to not confer a cumulative or chronological character to the nouns they modify.

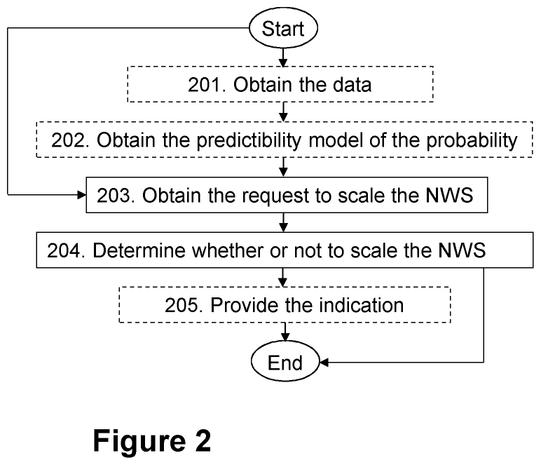

Embodiments of method, performed by the first node 111, will now be described with reference to the flowchart depicted in FIG. 2. The method may be understood to be handling scaling of a network slice in the communications network 100. The first node 111 operates in the communications network 100.

The method may comprise the actions described below. In some embodiments some of the actions may be performed. In some embodiments all the actions may be performed. In FIG. 2, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

Action 201

Network slicing may be understood to help optimizing the use of logical networks which may be separated from each other and may be created for specific uses or customers. The customers may in turn provide specific services to their subscribers. Different subscribers may be mapped to different network slices based on the subscription. Different slices may provide different level of quality of experience based on the throughput, delay and services. During the course of operations in the communications network 100, a request may be received to scale a network slice, e.g., to expand it. According to embodiments herein, prioritization of the network slices may be necessary if the available resources in the communications network 100 are scarce and one or more such requests are received. In order to prioritize network slices, e.g., when handling scaling of a network slice in the communications network 100, the first node 111 may first populate relevant information from different nodes to have a set of information available for implementing intelligence and automation for e.g., scaling network slices in and/or out.

In this Action 201, the first node 101 may obtain, from the one or more other nodes 114 operating in the communications network 100, data, such as historical data and/or current data.

Obtaining, may comprise receiving, collecting or gathering. In this Action 201, the obtaining may be implemented, e.g., via the respective fourth link 134.

In some examples, the first node 111 may be a DAF. In some examples, the one or more fourth nodes 114 may comprise one or more of a BSS, an NFVO, an EMS, a VNF and a provisioning system. Action 201 may therefore be understood as comprising populating the relevant information from different network functions (NFs) towards the DAF.

Currently, in 5G networks, relevant information for prioritizing network slices may be available in network functions individually, that is, it may be scattered, and not shared with any central node for a more informed and correlated decision. According to embodiments herein, specific information available at different one or more fourth nodes 114, such as the BSS, the EMS may be collected at the first node 111, e.g., the DAF. In some examples of this Action 201, real-time information may be obtained from the BSS to the DAF, or the NFVO to DAF call flow.

The data obtained in this Action 201 may be regarding one or more of the following types of data.

Obtained Revenue

A first type of data may be revenue obtained, by the communications network 100, from a provision of network slice services. All the services provided by a communication service provider may be understood to be monetized. The revenue may be generated by subscribers attached to a particular slice. This information may be utilized to calculate the actual revenue generated by a subscriber, by taking into account all the network usage and purchases made. The revenue information may be user specific, and/or device specific revenue information. This information may then be used by the first node 111 when deciding on prioritization among the customers and/or end users based on the revenue, instead of on a specific static configuration. Slice level revenue information may be provided by one of the one or more fourth nodes 114, such as a BSS.

In current networks, converged charging may be used, where both pre-paid and postpaid revenue information may be available with a BSS, in real-time. This may be understood to be in contrast to 4G, where postpaid Charging Data Records (CDRs) may be pushed in non real-time to a BSS system. Real-time view of the network slice profitability may be a relevant factor to consider when estimating the cost effectiveness, since the reduced network slice profitability may lead to reduced cost effectiveness of the resources. The information on revenue may be collected from the one or more fourth nodes 114, e.g., the BSS, which may have real-time information of charging and subscribed services. This information may be collected for long term usage at the first node 111, e.g., a Data Analysis (DAF) Network Function. The first node 111 may then be enabled to perform an analysis of historical and present data.

The data regarding revenue obtained may comprise network slice revenue information, e.g., monthly, weekly and yearly revenue information, as well as a slice's revenue specific to the real-time usage. For example, a slice may be inactive for months but may be currently getting a sudden high revenue due to a movie launch and signify increased revenue in near short term. Table 1 shows a non-limiting specific example of how average and real-time revenue information may map to different network slices:

TABLE 1

| Parameters | Slice 1 | | Slice 2 | | Slice 3 | |
|---|---|---|---|---|---|---|
| Monthly Revenue | 120K | USD | 160K | USD | 200K | USD |
| Revenue Real-time | 300 | USD | 800 | USD | 500 | USD |

Revenue information obtained may also comprise information on specific services, e.g., top up services, bought via operators, such as e.g., music or TV subscriptions, or subscription to apps. These apps may be paid for as part of an invoice, that is, post paid, or from a recharge amount, that is, prepaid. These services may be understood to provide additional revenue, and may be subscribed/unsubscribed on the fly.

This information may be stored at the first node 111, so that BSS information may be correlated with that provided by other nodes of the one or more fourth nodes 114 at the first node 111, e.g., one network function, to have the end to end view that may be needed to take a prioritization decision. In particular examples, the data regarding revenue that may be provided by the BSS may be correlated with network function specific information provided by an NFVO system, as described in the third type of data below.

Provision of Network Slice Services

A second type of data may be provision of network slice services in the communications network 100. As scaling may be performed at VNF level, information related to mapping of various VNFs to network slices, that is, which VNFs may be a part of which network slice, e.g., VNFs per slice, number, type, such as AMF, SMF etc., and identifier, may be provisioned in the first node 111, e.g., the DAF. In other words, since a request may be obtained for scaling one VNF, which network slice is represented by this VNF may need to be identified. One node of the one or more fourth nodes 114 that may provide this type of data may be a provisioning system.

Resource Availability

A third type of data may be resource availability for the provision of network slice services in the communications network 100. The resource availability may comprise information on the available resource pool, such as number of resources currently used for a slice and total resources available. The first node 111 may obtain this information at any change, and maintain a historical record for all these transactions. This information may be understood to be important so that the cost of particular network slice may be calculated. Table 2 shows a non-limiting specific example of a change of resources, in terms of number of Access and Mobility Management Functions (AMFs), Session Management functions (SMFs) and User plane functions (UPFs), that may be experienced over time, over three days, in three different network slices: NS1, NS2 and NS3.

TABLE 2

| Network | | | |
|---|---|---|---|
| Slice | Day 1 | Day 2 | Day 3 |
| NS1 | 2 AMF, 4 SMF, | 2 AMF, 5 SMF, | 2 AMF, 5 SMF, |
| | 11 UPF | 11 UPF | 10 UPF |
| NS2 | 1 AMF, 1 SMF, | 2 AMF, 2 SMF, | 2 AMF, 2 SMF, |
| | 2 UPF | 2 UPF | 2 UPF |
| NS3 | 8 AMF, 16 SMF, | 8 AMF, 18 SMF, | 8 AMF, 18 SMF, |
| | 4 UPF | 4 UPF | 6 UPF |

Based on network requirements, network slices, e.g., VNFs, may be expanded or reduced dynamically. The first node 111 may obtain scaling data, that is, expansion and contraction, or from one of the one or more fourth nodes 114. In some examples, the data on resource availability may be provided by an NFVO system, as one of the one or more fourth nodes 114 or as the second node 112. The NFVO may be understood to keep the information on the available resource pool and share such information at any change of resources. Each request to dynamically expand or reduce a network slice may be understood to be processed by the NFVO and may then be obtained by the first node 111, e.g., the DAF. For examples wherein the one of the one or more fourth nodes 114 may be the NFVO, and the first node 111 may be the DAF, the data may be obtained by the DAF in a new proposed interface herein. In existing methods, this interface does not exist.

In some examples, the data on resource availability may be provided by an Element Management System for the Virtual Network Function (EMS/VFN), as another node of the one or more fourth nodes 114.

The data may be resource availability for the provision of network slice services in the communications network 100 may be obtained in a message that may be clubbed with the previous message comprising the revenue obtained, by the communications network 100, from the provision of network slice services.

Cost of Resources

A fourth type of data may be cost of resources for the provision of network slice services in the communications network 100.

The CSP may incur a cost for each resource which may be used by the network slice. This resource may be a) physical, such as e.g., servers and Internet Protocol (IP) infrastructure etc., b) logical, such as e.g., bandwidth used from an Internet Service Provider (ISP), electricity used for power and air conditioning etc., and/or c) application based, such as e.g., 3PP, or own licenses etc.

The cost of the network resources may be calculated by one or more fourth nodes 114, e.g., an OSS, as a single unit per resource based on the averages of CApital EXpenditures (CAPEX) and OPerating EXpense (OPEX), but for simplicity a single value may be used herein as cost. For example, 20 USD per server per month. Table 3 provides a non-limiting specific example of such costs.

TABLE 3

| Resource | Cost | | Remarks |
|---|---|---|---|
| CPUx | X | USD | Avg. Cost of CPU of type X |
| CPUy | Y | USD | Avg. Cost of CPU of type Y |
| Memory | M | USD | Avg. Cost of Memory per GB |
| Storage | S | USD | Avg. Cost of Storage per GB |
| Bandwidth | B | USD | Avg. Cost of Bandwidth per Gbps |
| VM1 | Z | USD | 1 VM (1 CPU, 500 GB, 100 Mbps) |
| VM2 | W | USD | 2 VM (10 CPU, 2000 GB, 500 Mbps) |

This information may be obtained by the first node 111 for a long term perspective from one of the one or more fourth network nodes 114, which may be an external provisioning system, such as an inventory management system or OSS, which may keep track of available and used resources. The cost per resource may be calculated offline, and reviewed periodically. Any necessary updates may be made as may be required.

The first node 111 may then calculate the cost per network slice based on the cost per resource, or network function (NF), and the total number of resources per slice. The cost related to VNFs which may be shared among multiple network slices may be calculated based on a share of subscribers or by dividing the cost equally among network slices. This may be also referred to as shared network slice subnet.

The collection of data in this Action 201, may be understood to be part of a pre-collection phase of embodiments herein. The first node 111 may then, in a post-collection phase, analyze all collected data and use the information available and/or derived at the first node 111 to make policy decisions. Herein the policy decisions may be understood to be relevant for use in prioritizing a network slice. Further particularly, to optimize a prioritization of network slices in order to take a decision regarding a slice scaling request. The post-collection phase may comprise one or more of the following Actions 202-205.

Action 202

In some situations wherein the communications network 100 may be, e.g., congested, more than one network slice scaling request for expansion may be received for the same, or overlapping, time period. In such circumstances, the prioritization may need to be performed on both requests if the communication network 100 cannot grant both.

However, in other circumstances, only one request may be received first. If this request were to be granted, a later coming request for the same, or overlapping, time period, deserving a higher priority may not be granted. According to the foregoing, it would be beneficial for the first node 111 to be able to predict the expansion\scaling request based on previous such situations, e.g., if there is network expansion at a peak hour of 8 PM to 9 PM every weekend, then the first node 111 may pick-up this pattern from historical data and may take pro-active action near this peak-hour time. Similar predictions may be made to predict requests to scale out network slices. While slice expansion is mostly used herein as an example of slice scaling, it will be understood that prioritization may also be used for contraction procedures, that is to scale out network slices.

In this Action 202, the first node 111 may obtain a predictability model of a probability of, having obtained a request to scale a network slice during a time period, obtaining one or more further requests to scale other network slices during the time period. During the time period may be understood as comprising a total overlap of the time period, or a partial overlap of the time period.

In other embodiments, the obtaining in this Action 202 of the predictability model may comprise calculating, determining or deriving the model, e.g., based on using a machine learning procedure. The machine learning procedure may be for example, Random Forest and Bayesian Modeling, or based on analytics algorithms such as, e.g., linear regression, logistic Regression, classification and Regression Trees, etc.

The obtaining in this Action 202 of the predictability model may be further based on the obtained data in Action 201.

In some embodiments, the obtaining in this Action 202 of the predictability model may comprise receiving the model, e.g., from the third node 113 operating in the communications network 100. That is, the derivation of the predictability model may be performed autonomously by the first node 111, or by another node, such as the third node 113, and then obtained by the first node 111.

Action 203

In this Action 203, the first node 111, obtains, from the second node 112 operating in the communications network 100, a request to scale a network slice.

Obtaining the request may be understood as receiving the request, e.g., via the first link 131.

A scaling request may be generated as more resources may be required, e.g., to handle subscriber traffic. As per the European Telecommunications Standards Institute (EISI) Management and Orchestration (MANO) Architecture, a scaling request may be generated in the following three cases.

The first case may be auto-scaling, in which the third node 113, e.g., a VNF Manager, may monitor the state of a VNF instance and trigger the scaling operation when certain conditions may be met. For monitoring a VNF instance's state, it may for instance track infrastructure-level and/or VNF-level events. Infrastructure-level events may be generated, for example, by a VIM. VNF-Level events may be generated by the VNF instance or its EM.

The second case may be on-demand scaling, in which a VNF instance or its EM may monitor the state of a VNF instance and trigger a scaling operation through an explicit request to the VNF Manager.

The third case may be scaling based on a management request, where the scaling request may be triggered by a sender, e.g., an OSS/BSS or operator, towards VNFM via the NFVO.

The scaling request may have been generated by the third node 113, e.g., the VNF or EM or another management entity, and provided to one of the one or more fourth nodes 114, such as e.g., the NFVO. In existing methods, the NFVO takes a scaling decision based on the configured policies and available resources. According to embodiments herein, the second node 112, e.g., the NFVO, may check with the first node 111, e.g., the DAF, for these requests. Information related to the scaling request may be obtained by the first node 111 from the NFVO.

In some embodiments, the request may be received based on an amount of available resources for the network slice being below a threshold. That is, the request may be obtained only when the available resources, e.g. number of CPUs, may be below a certain threshold e.g. 20%. In such a case, the second node 112, e.g., the NFVO, may check with the first node 111 for a priority of the network slice before granting the request. In some examples wherein the first node 111 is the DAF and the second node 112 is the NFVO, a new interface between NFVO and DAF and be created, whereby the NFVO on this interface may provide all the scaling related information to the DAF.

Action 204

As highlighted earlier, the first node 111 may have been populated with relevant information comprising, but not limited to user specific revenue information, information related to scaling requests, e.g., historical data on scaling requests, available resources and cost of resources.

In this Action 204, the first node 111, determines, whether or not to scale the network slice, that is, whether or not to grant the obtained request. The determining in this Action 204 may be based on the information obtained in Action 201. This information may be gathered by the first node 111, and analyzed to calculate a priority of the network slice for expansion, to e.g., scale out or scale in.

According to embodiments herein, in consideration of, for example, the use-case of multiple network slice, that is, VNF, scaling in the communications network 100 with limited resources, the collected data may be used to make optimal decisions related to network slice priority so that the resources may be allocated in the most cost effective way, that is, based on the cost effectiveness of the network slice. As mentioned earlier, each network slice has accompanying costs in terms of the resources used and revenue in terms of aggregated, attached, subscriber revenue. These factors may be considered in embodiments herein while allocating resources to different network slices.

Therefore, the determining in this Action 204 is based on a cost effectiveness of the network slice. In some embodiments, the determining 204 in this Action 204 may comprise obtaining a priority of the received request to scale the network slice, the priority being based on the cost effectiveness of the network slice. The cost effectiveness of the network slice may be understood herein to comprise the cost effectiveness of the network slice if the request to scale were to be granted, that is on an estimate of the cost effectiveness of the scaled network slice.

The cost effectiveness of the network slice may factor in a revenue obtained from the network slice. In embodiments herein, network slices may be prioritized based on the information related to cost effectiveness, that is, of cost, factoring in the generated revenue for each network slice. The information that may have been obtained in Action 201 may be used to analyze and decide the priority of a slice based on the cost effectiveness of the slice, factoring in the revenue of each subscriber in that slice.

Determining may be understood as calculating, deriving, deciding, or similar. In some embodiments, the determining 204 may be based on the obtained data in Action 201. The first node 111 may use machine learning and\or pattern recognition algorithms to process the data for optimal decision making. This may be viewed as a super set of a 3GPP network function, such as e.g., a Network Data Analytics Function (DAF), that is, a network slice, and related load factors, Management Data Analytics Function MDAF, OSS specific information, or a separate non-standard entity for making decisions related to optimal resource usage.

By using an aggregate of revenue value and cost, a cost effectiveness value may be derived, which may indicate how cost effective a slice is. This value may be further optimized by taking into consideration the fixed and variable costs of the infrastructure.

The higher the value, the more cost effective the slice. Based on the above criteria, a slice may be provided a higher or a lower priority.

In some embodiments, the determining in this Action 204 may be based on an amount of available resources for the network slice being below the threshold. In some embodiments, as described earlier, the request may only be obtained by the first node 111 when the available resources are below the threshold. In other embodiments, the request may always be forwarded to the first node 111, and the first node 111 may then perform its determination on whether the request should be granted or not, based on a slice prioritization. For example, to ensure that enough resources may be in reserve for higher cost effective slices, the first node 111, which may be, e.g., the DAF, may consider using prioritization after the resource utilization is more than 80%. That is, when e.g., 80% of the infrastructure, such as compute, storage, network, may be being used in the data center. In this case, the threshold is therefore 20% of the infrastructure. It may be understood that the value of the threshold may be configured, e.g., set, by an operator the communications network 100.

In some embodiments, the determining 204 may be based on the obtained predictability model in Action 202. The amount of available resources may be based on the obtained predictability model in Action 202. That is, it may be based on a predicted availability of the resources. Therefore, even if only one request is received for the time period, the first node 111 may perform its determination on whether to grant it or not based the predicted probability of receiving one or more other, not yet received, requests to scale other network slices, for the same, or overlapping, time period. Hence, in some examples the obtaining of the priority of the received request to scale the network slice, may be based on obtaining a respective priority of one or more additional requests to scale other network slices, or based in the absence of additional received one or more additional requests.

To summarize the foregoing, in this Action 204, the first node 111 may decide which network slice may be scaled and which may not be scaled, based on the received scaling request, the real, or predicted available resources, cost, revenue and the obtained data, e.g., historical data.

Action 205

In this Action 205, the first node 111 may provide an indication of a result of the determination to the second node 112.

Providing may be understood as e.g., sending, for example, via any of the first link 131. The result of the determination may be understood as the decision. As mentioned earlier, in some examples, the first node 111 may be a DAF, e.g., in a 5G network. In current call flows, the DAF is not used for slice scaling scenarios. In some examples, the second node 112 may be the NFVO, e.g., in a 5G network. According to embodiments herein, a new interface between the NFVO and the DAF may be provided for including the cost effectiveness based selection.

According to embodiments herein, during every scaling request, 1) the NFVO may provide scaling information to the DAF, which the DAF may store for future references, and 2) the DAF may provide the decision related to go/no-go for the scaling, especially for the expansion case during congestion time. After the scaling operation may be completed as per normal flow, the second node 112 may then update the first node 111 about the available resources, as another performance of Action 201.

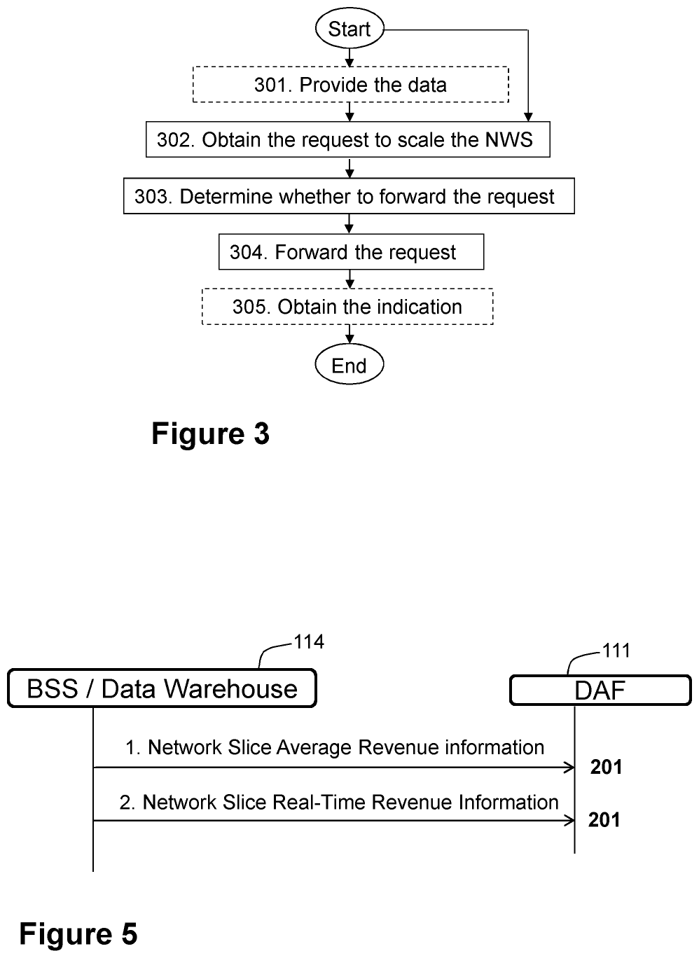

Embodiments of a method performed by any second node 112 will now be described with reference to the flowchart depicted in FIG. 3. The method is for handling the scaling of the network slice in the communications network 100. The second node 112 operates in the communications network 100.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 3, optional actions are represented in boxes with dashed lines.

The detailed description of some of the following corresponds to the same references provided above, in relation to the actions described for the first node 111, and will thus not be repeated here to simplify the description. For example, the second node 112 may be an NFVO and the first node 111 may be a DAF.

Action 301

In this Action 301, the second node 112 provides, to the first node 111 the data regarding provision of network slice services in the communications network 100.

Providing may be understood as e.g., sending or sharing, for example, via the first link 131.

In some embodiments, the second node 112 may provide the first information to the first node 111 every time there may be change in the provision of network slice services in the communications network 100. It may be understood that in the context of Action 301, the second node 112 may be an example of the one or more fourth nodes 114.

Action 302

After providing the first information to the first node 111, in this Action 302, the second node 102 obtains, from the third node 113 operating in the communications network 100, the request to scale a network slice.

The obtaining, may comprise receiving, e.g., via the third link 133.

In some examples, as stated earlier, the third node 113, may be the VNF.

Action 303

In this Action 303, the second node 112 determines whether or not to forward the request to the first node 111 operating in the communications network 100. The determining in this Action 303 is based on the amount of available resources in the communications network 100 to scale the network slice being below the threshold.

The second node 112, before performing the determination, may check the obtained resource request, e.g., CPU, memory, IP, etc., against its capacity database for free resource availability, in order to check the resource available for this scaling. The second node 112 may also validate the request for policy conformance.

The second node 112 may, in particular check if the available resources are less than the threshold, e.g., 20%. If so, it may need to enforce the slice prioritization. That is, the second node 112 may determine to forward the request only when the available resources, e.g. number of CPUs, may be below a certain threshold, e.g. 20%. In such cases, since the second node 112 may know there may not be enough resources available to grant all the received requests, or all the requests predicted to be received for a time period, the second nodes 112 may check with the first node 111 the priority of the network slice. To get the decision based on slice priority, the second node 112 may send the request to the first node 111 in the next action.

In determining whether or not to forward the request to the first node 111 in this Action 303, the second node 112 may obtain the predictability model of the probability of, having obtained the request to scale the network slice during the time period, obtaining one or more further requests to scale other network slices during the time period, in a similar way to how it was described for the first node 111 in Action 202. That is, the second node 112 may obtain the predictability model itself, or receive it from another node, e.g., the third node 113, or the first node 111.

Action 304

In this Action 304, the second node 112 forwards the request to the first node 111 operating in the communications network 100, based on a result of the determining 303. That is, the second node 112 may forward the request if it determines to forward it in Action 303, and it may refrain from forwarding the request if it determines that it is to refrain from forwarding the request in Action 303.

Forwarding may be understood as sending or providing, e.g., via the first link 131.

For the examples wherein the second node 112 may be an NFVO, and the first node 111 may be a DAF, as stated earlier, the new interface between NFVO and DAF may be created, whereby the NFVO may provide on this interface all the scaling related information to the DAF.

Action 305

In embodiments wherein the second node 112 may have forwarded the request in Action 304, the second node 112 may, in this Action 305, obtain the indication of the response to the forwarded request from the first node 111. The indication may be based on the cost effectiveness of the network slice.

If the indication is that the request is granted, after the scaling operation may be completed as per normal flow, the second node 112 may then update the first node 111 about the available resources, which may be understood as another example of Action 301.

The methods just described as being implemented by the first node 111, the second node 112, the third node 113, and the one or more fourth nodes 114, will now be described in further detail with specific non-limiting examples in the next figures.

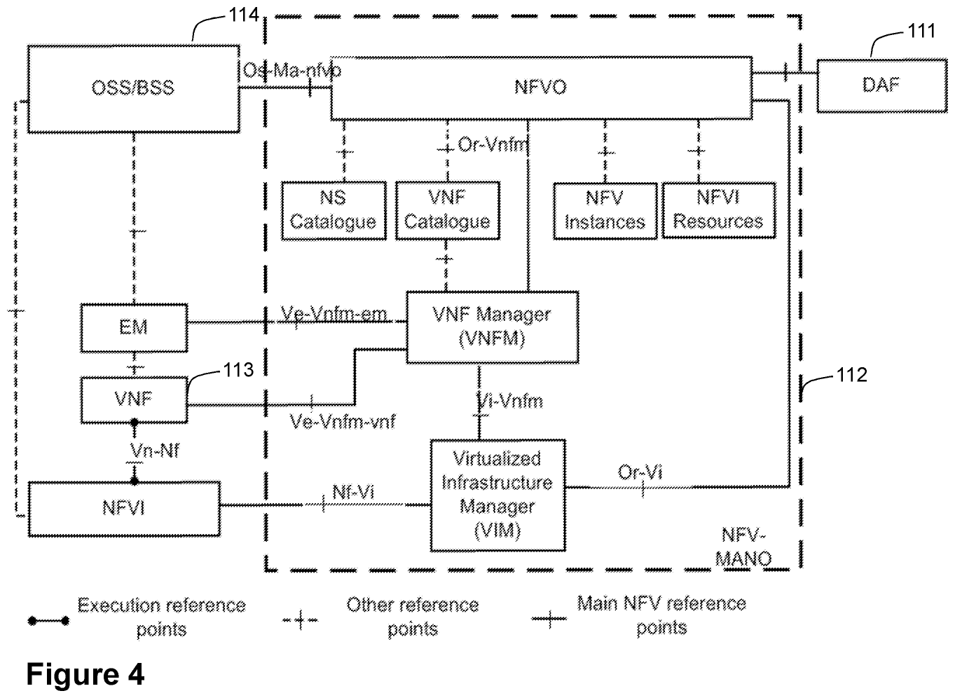

FIG. 4 is a schematic diagram depicting a non-limiting example of the communications network 100 according to embodiments herein having an ETSI NFV

Architecture, and depicting an NFVO to DAF connectivity. In this non-limiting example, the first node 111 is a DAF, the second node 112 is an NFVO, the third node 113 is a VNF, and the one or more fourth nodes 114 comprise a BSS/Data Warehouse. A complete description of the architecture may be found in the ETSI MANO architecture description available at: www(dot)etsi(dot)org/deliver/etsi_gs/NFV-MAN/001_099/001/01(dot)01(dot)01_60/gs_NFV-MAN001v010101p(dot)pdf.

FIG. 5 is a signalling diagram depicting a non-limiting example of embodiments herein. In this non-limiting example, the first node 111 is a DAF, and the one or more fourth nodes 114 comprise a BSS/Data Warehouse. The Figure illustrates the BSS/Data Warehouse providing inputs to the DAF. The call flow depicted in FIG. 5 as follows: at 1, in accordance with Action 201, the first node 111 obtains network slice revenue information, e.g., monthly and weekly revenue information from one of the one or more fourth nodes 114. At 2, also in accordance with Action 201, the first node 111 obtains a slice's revenue specific to the real-time usage, from one of the one or more fourth nodes 114. In existing methods, a DAF typically stores network slice and related congestion information, such as e.g., load level, etc. The BSS data on revenue and cost, may enable the DAF to provide cost-effectiveness based information.

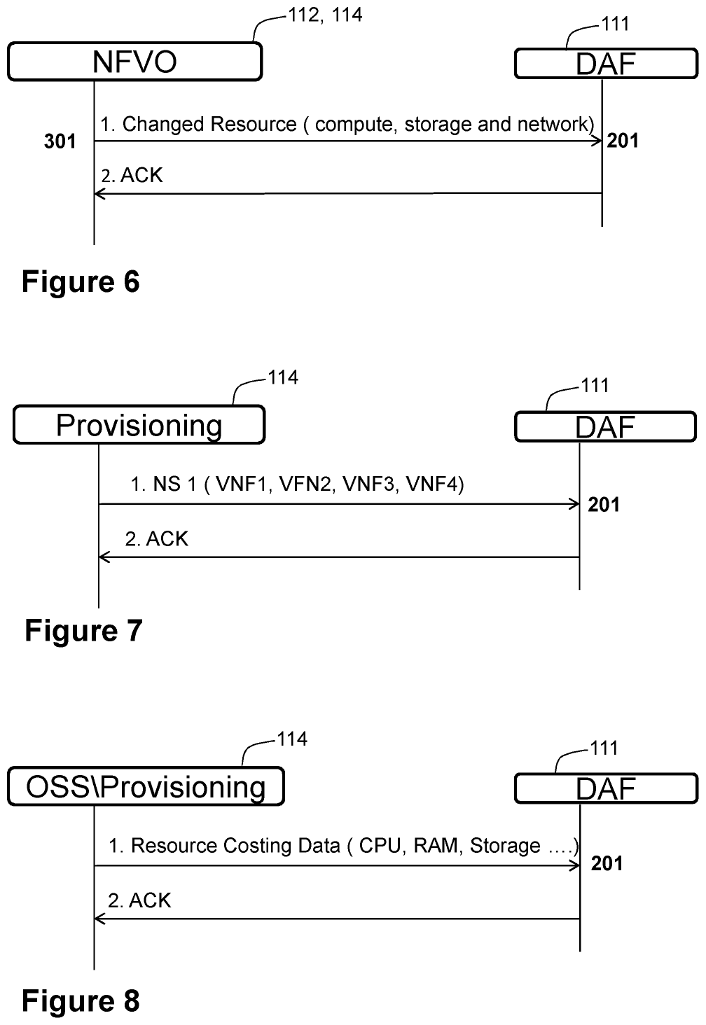

FIG. 6 is a signalling diagram depicting a non-limiting example of embodiments herein. In this non-limiting example, the first node 111 is a DAF, and the one or more fourth nodes 114 comprise a NFVO. The Figure illustrates how at 1, in accordance with Action 201, the first node 111 obtains information on a change of the available resource pool from one of the one or more fourth nodes 114. At 2, the DAF acknowledges (ACK) the received data.

FIG. 7 is another signalling diagram depicting another non-limiting example of embodiments herein. In this non-limiting example, the first node 111 is the DAF, and the one or more fourth nodes 114 comprise a Provisioning system. The Figure illustrates, at 1, the Provisioning system providing mapping details between a network slice, NS1, and different VNFs, to the DAF, according to Action 201. At 2, the DAF acknowledges the received data.

FIG. 8 is a signalling diagram depicting a non-limiting example of embodiments herein. In this non-limiting example, the first node 111 is a DAF, and the one or more fourth nodes 114 comprise an OSS/Provisioning node. The Figure illustrates how at 1, in accordance with Action 201, the first node 111 obtains information on resource cost data, e.g., CPU, storage, RAM, etc . . . , from one of the one or more fourth nodes 114. At 2, the DAF acknowledges the received data.

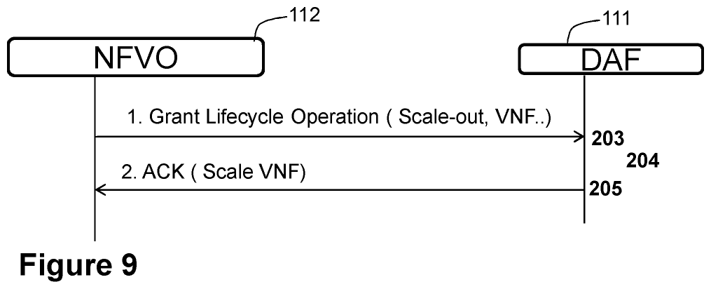

FIG. 9 is a signalling diagram depicting a non-limiting example of embodiments herein for collection of scaling related data. In this non-limiting example, the first node 111 is a DAF, and the second node 112 is an NFVO. The Figure illustrates how at 1, in accordance with Action 203, first the node 111 obtains VNF scale-out request details from the second node 112. The first node 111 analyzes the inputs in accordance with Action 204, and at 2, in accordance with Action 205, it provides the response with permit or deny options.

Two particular examples of call procedures that may be performed according to embodiments herein to allocate resources for network slice scaling will be described in the next two figures. In both cases, one of the one or more fourth nodes 114 comprise an NFVO that controls the scaling process by granting resources, in the event of congestion in the communications network 100.

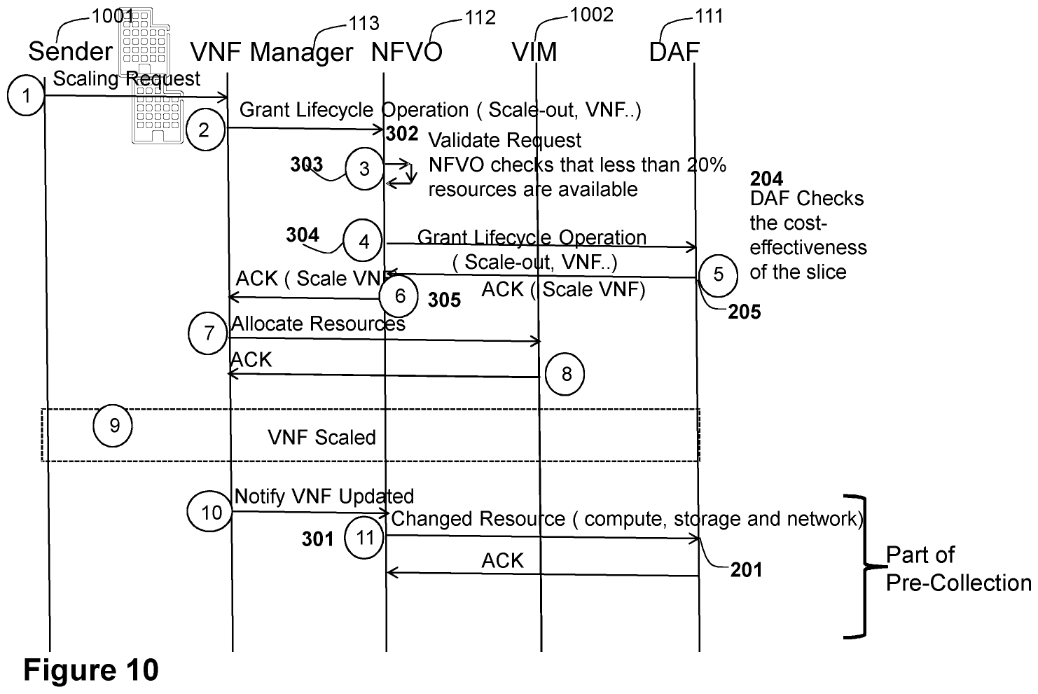

FIG. 10 is a signalling diagram depicting a non-limiting example of a call procedure for a network slice scaling, wherein the resource allocation is performed by the third node 113, wherein the third node 113 is a VNF Manager. In this non-limiting example, the first node 111 is a DAF, and the second node 112 is an NFVO. The signalling flow in this non-limiting example is the following, according to the numbering depicted in FIG. 10.

At 1, the sender 1001 initiates the scaling request. In the Figure, the sender 1001 sends the scaling request to the third node 113, which in this example is the VNF Manager. The sender may be the VNF Manager, in the event of e.g., an auto-scaling request, or an OSS/BSS component. In case the VNF Manager is the one issuing the scaling request, some of the following flows may be simplified.

At 2, the VNF Manager, according to Action 302, requests granting to the NFVO for the VNF expansion based on the specifications listed in the Virtualized Network Function

Descriptor (VNFD), such as CPU, memory, IP, etc., using the operation Grant Lifecycle Operation of the VNF Lifecycle Operation Granting interface.

At 3, according to Action 303, the NFVO takes a scaling decision and checks the resource request, e.g., CPU, memory, IP, etc., against its capacity database for free resource availability. The NFVO may also validate the request for policy conformance. It may also checks the resource available for this scaling. In this example, the NFVO realizes that the available resources are less than the threshold, which is here 20%, so it may need to enforce the slice prioritization. To get the decision based on slice priority, it sends the request to DAF in the next action.

At 4, according to Action 304, the NFVO sends the VNF and scaling request related information to the DAF. The DAF, according to Action 204, checks the cost effectiveness based priority and decides that this slice can be scaled.

At 5, according to Action 205, the DAF decision is provided to NFVO about whether access is granted or not. In this example, the scaling request is granted, by sending an acknowledgement.

The NFVO may otherwise optionally do resource reservation for the requested resources by using the Create Resource Reservation operation over the Virtualized Resources management interface.

At 6, according to Action 305, the NFVO obtains the response from the first node 111, and grants the scale-out operation of the VNF to the VNF Manager and sends back sufficient information to further execute the scaling operation.

At 7, the VNF Manager sends the request to create and start the VMs as appropriate and as instructed by the NFVO, sending to the VIM 1002, a VIM Identifier and Virtual Machines (VMs) parameters using the operations Allocate Resource or Update Resource or Scale Resource of the Virtualized Resources Management interface.

At 8, the VIM 1002 creates and starts the VMs and the relevant networking resources, then acknowledges successful operation to the VNF Manager.

At 9, the VNF performs any necessary operations for the VNF creation and configuration to scale the VNF.

At 10, the VNF Manager reports the successful VNF expansion to the NFVO using the VNF Lifecycle Change Notification interface. The NFVO now is aware that the new VNF configuration is instantiated in the infrastructure. The NFVO maps the VNF to the proper VIM and resource pool.

At 11, according to Action 301, the NFVO updates the DAF with updated resource availability for making future decisions related to the slice priority, which is obtained by the DAF in agreement with Action 201, and then acknowledged by the DAF. This particular actions 301, 201 may be understood, as indicated in the Figure, to be part of the pre-collection phase, adding new data for future slice scaling decisions.

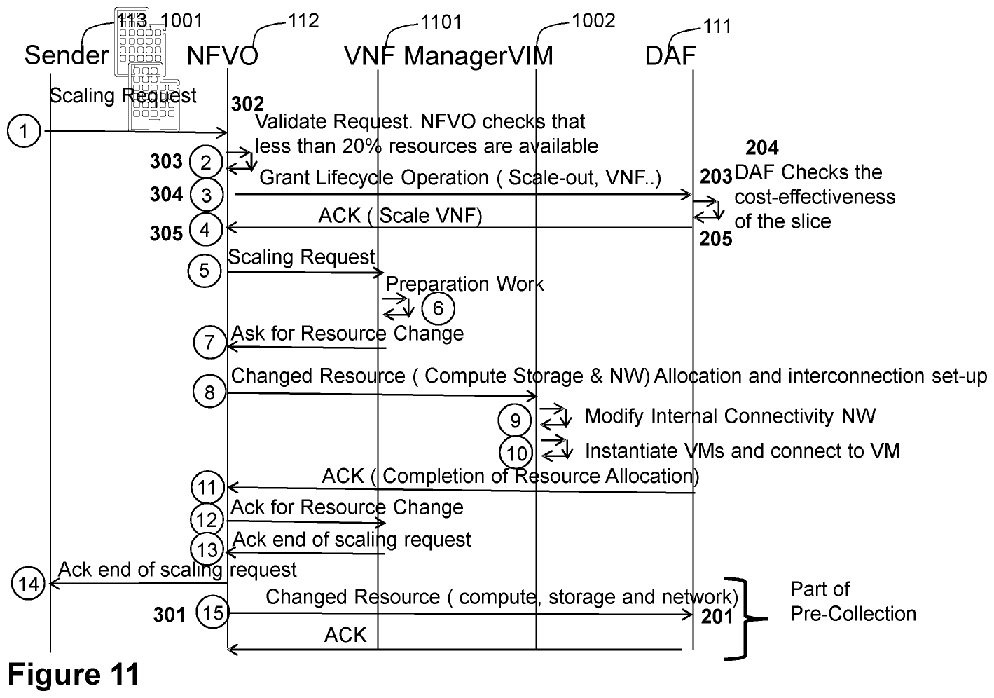

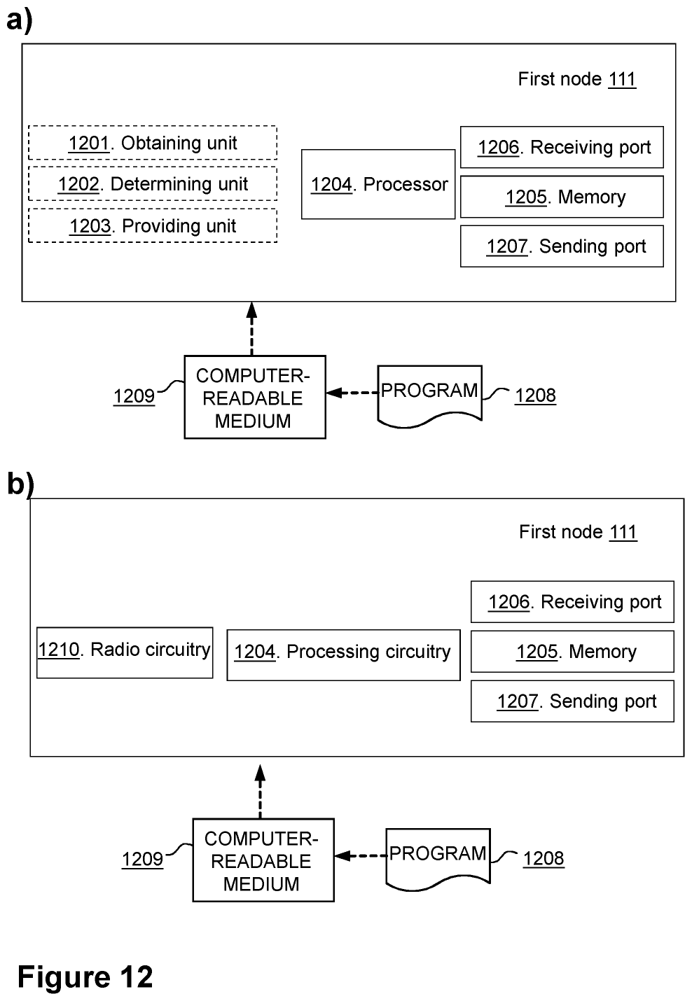

FIG. 12 is a signalling diagram depicting a non-limiting example of a call procedure for a network slice scaling, wherein the resource allocation is performed by the second node 112, wherein the second node 112 is an NFVO. In this non-limiting example, the first node 111 is a DAF, and the third node 113 is a VNF Manager. The signalling flow in this non-limiting example is the following, according to the numbering depicted in FIG. 11.

At 1, the NFVO, according to Action 302, receives the scaling request from the third node 113, here the sender 1001. The sender 1001 may be the VNF manager 1101, or the OSS/BSS, or else the scaling request may be manually triggered by an operator. In case the VNF Manager is the one issuing the scaling request, some of these flows may be simplified. In the particular example depicted in this Figure, the sender 1001 may be, e.g. the OSS using the operation Scale VNF of the VNF Lifecycle Management interface. In case the VNF Manager 1101 is issuing the scaling request, some of the steps of this procedure may be further optimized.

At 2, according to Action 303, the NFVO validates the request for policy conformance. It also checks the resource available for this scaling. It realizes that available resources are less than the threshold, here also 20%, so it may need to enforce the slice prioritization. To get the decision based on slice priority, it sends the request to DAF, according to Action 304.

At 3, according to Action 304, the NFVO sends the VNF and scaling request related information to the DAF. The DAF obtains the request according to Action 203, and checks, according to Action 204, the cost-effectiveness based priority and decides that this slice can be scaled.

At 4, according to Action 205, the DAF decision is provided to NFVO, which is obtained by the NFVO according to Action 305. The decision is to grant the request, and it is therefore sent as an acknowledgement.

At 5, the NFVO finds the VNF Manager 1101 relevant for this VNF type. Optionally, the NFVO runs a feasibility check of the VNF scaling request to reserve resources before performing the actual scaling. The NFVO sends the scaling request to the VNF Manager 1101 with the scaling data and, if resource reservation has been done, the reservation information using the operation Scale VNF of the VNF Lifecycle Management interface.

At 6, the VNF Manager 1101 executes any needed preparation work, such as request validation, parameter validation, etc. This may include modifying and/or complementing the input scaling data with VNF lifecycle specific constraints. If resource reservation was done by NFVO then the VNF Manager 1101 may skip this step.

At 7, the VNF Manager 1101 calls the NFVO for resource change using the operation Allocate Resource or Update Resource or Scale Resource of the Virtualized Resources Management interface.

At 8, the NFVO requests from the VIM 1102 allocation of changed resources, such as compute, storage and network, that may be needed for the scaling request using the operations Allocate Resource or Update Resource or Scale Resource of the Virtualized Resources Management interface.

At 9, the VIM 1102 modifies as needed the internal connectivity network (NW).

At 10, the VIM 1102 creates and starts the needed new compute (VMs) and storage resources and attaches new instantiated VMs to internal connectivity network.

At 11, an acknowledgement of completion of resource change is sent back to the NFVO.

At 12, the NFVO acknowledges the completion of the resource change back to VNF Manager 1101.

At 13, the VNF Manager 1101 configures the scaled VNF as necessary using the add/create/set config object operations of the VNF configuration interface. The VNF Manager 1101 acknowledges the end of the scaling request back to the NFVO.

At 14, the NFVO acknowledges the end of the scaling request back to the requester.

At 15, the NFVO, according to Action 301, updates the DAF with updated resource availability for making future decisions related to the Slice Priority. The DAF obtains the update in accordance with Action 201, and sends back an acknowledgement.

As a simplified example overview of the foregoing description and examples, embodiments herein may be understood to relate to methods of prioritizing network slice scaling based on cost effectiveness. Storing and analyzing the historical scaling data may be understood to help in making predictions about the network from a cost-effectiveness perspective.

One advantage of embodiments herein is that they enable prioritizing a network slice having higher cost effectiveness, rather than treating all slices in the same way. Thanks to these advantages, network resources may be managed more efficiently, as for example, more users may be provided with services based on network slices. A further advantage of embodiments herein is that they enable to make a network related decision such as e.g., slice resource allocation based on the network slice cost effectiveness. Thanks to these advantages, costs due to network resources may be managed more in a more cost-effective way.

FIG. 12 depicts two different examples in panels a) and b), respectively, of the arrangement that the first node 111 may comprise to perform the method actions described above in relation to FIG. 2. In some embodiments, the first node 111 may comprise the following arrangement depicted in FIG. 12a. The first node 111 may be understood to be for handling the scaling of the network slice in the communications network 120. The first node 111 is configured to operate in the communications network 120.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the first node 111, and will thus not be repeated here. For example, the first node 111 may be a DAF.

The first node 111 is configured to, e.g. by means of an obtaining unit 1201 within the first node 111 configured to, obtain, from the second node 112 configured to operate in the communications network 120, the request to scale a network slice.

The first node 111 is also configured to, e.g. by means of a determining unit 1202 within the first node 111 configured to, determine whether or not to scale the network slice. To determine is configured to be based on a cost effectiveness of the network slice. The first node 111 may be configured to determine, e.g., using the machine-implemented learning procedure.

The cost effectiveness of the network slice may be configured to factor in the revenue configured to be obtained from the network slice.

In some embodiments, the first node 111 is configured to, e.g. by means of a providing unit 1203 within the first node 111 configured to, provide an indication of a result of the determination to the second node 112.

In some embodiments, the request may be configured to be received based on the amount of available resources for the network slice being below the threshold.

In some embodiments, the request may be to scale the network slice during the time period. In such embodiments, the first node 111 may be further configured to, e.g. by means of the obtaining unit 1201 further configured to, obtain the predictability model of the probability of obtaining one or more further requests to scale other network slices during the time period. In such embodiments, to determine may be further configured to be based on the predictability model configured to be obtained.

To obtain the predictability model may be configured to be one of: i)

from the third node 113 configured to operate in the communications network 120, and, ii) based on using a machine learning procedure.

In some embodiments, the first node 111 may be further configured to, e.g. by means of the obtaining unit 1201 further configured to, obtain, from the one or more other nodes 114 configured to operate in the communications network 120, the data regarding one or more of: i) the revenue obtained, by the communications network 120, from the provision of network slice services, ii) the provision of network slice services in the communications network 120, iii) the resource availability for the provision of network slice services in the communications network 120, and iv) the cost of resources for the provision of network slice services in the communications network 120. In such embodiments, to determine may be further configured to be based on the data configured to be obtained.

The embodiments herein may be implemented through one or more processors, such as a processor 1204 in the first node 111 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1205 comprising one or more memory units. The memory 1205 is arranged to be used to store obtained information, store data, configurations, schedulings, and applications etc. to perform the methods herein when being executed in the first node 111.

In some embodiments, the first node 111 may receive information from, e.g., the second node 112, the third node 113, and/or the one or more fourth nodes 114, through a receiving port 1206. In some examples, the receiving port 1206 may be, for example, connected to one or more antennas in the first node 111. In other embodiments, the first node 111 may receive information from another structure in the communications network 120 through the receiving port 1206. Since the receiving port 1206 may be in communication with the processor 1204, the receiving port 1206 may then send the received information to the processor 1204. The receiving port 1206 may also be configured to receive other information.

The processor 1204 in the first node 111 may be further configured to transmit or send information to e.g., the second node 112, the third node 113, and/or the one or more fourth nodes 114, through a sending port 1207, which may be in communication with the processor 1204, and the memory 1205.

Those skilled in the art will also appreciate that any of the units 1201-1203 described above may refer to a combination of analog and digital circuits, and/or one or more processors configured with software and/or firmware, e.g., stored in memory, that, when executed by the one or more processors such as the processor 1204, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1201-1203 described above may be the processor 1204 of the first node 111, or an application running on such processor.

Thus, the methods according to the embodiments described herein for the first node 111 may be respectively implemented by means of a computer program 1208 product, comprising instructions, i.e., software code portions, which, when executed on at least one processor 1204, cause the at least one processor 1204 to carry out the actions described herein, as performed by the first node 111. The computer program 1208 product may be stored on a computer-readable storage medium 1209. The computer-readable storage medium 1209, having stored thereon the computer program 1208, may comprise instructions which, when executed on at least one processor 1204, cause the at least one processor 1204 to carry out the actions described herein, as performed by the first node 111. In some embodiments, the computer-readable storage medium 1209 may be a non-transitory computer-readable storage medium, such as a CD ROM disc, a memory stick, or stored in the cloud space. In other embodiments, the computer program 1208 product may be stored on a carrier containing the computer program, wherein the carrier is one of an electronic signal, optical signal, radio signal, or the computer-readable storage medium 1209, as described above.

The first node 111 may comprise an interface unit to facilitate communications between the first node 111 and other nodes or devices, e.g., the second node 112, the third node 113, and/or the one or more fourth nodes 114. In some particular examples, the interface may, for example, include a transceiver configured to transmit and receive radio signals over an air interface in accordance with a suitable standard.

In other embodiments, the first node 111 may comprise the following arrangement depicted in FIG. 12b. The first node 111 may comprise a processing circuitry 1204, e.g., one or more processors such as the processor 1204, in the first node 111 and the memory 1205. The first node 111 may also comprise a radio circuitry 1010, which may comprise e.g., the receiving port 1206 and the sending port 1207. The processing circuitry 1204 may be configured to, or operable to, perform the method actions according to FIG. 2, in a similar manner as that described in relation to FIG. 12a. The radio circuitry 1010 may be configured to set up and maintain at least a wireless connection with the second node 112, the third node 113, and/or the one or more fourth nodes 114.

Hence, embodiments herein also relate to the first node 111 operative to handle scaling of a network slice in the communications network 120, the first node 111 being operative to operate in the communications network 120. The first node 111 may comprise the processing circuitry 1204 and the memory 1205, said memory 1205 containing instructions executable by said processing circuitry 1204, whereby the first node 111 is further operative to perform the actions described herein in relation to the first node 111, e.g., in FIG. 2.

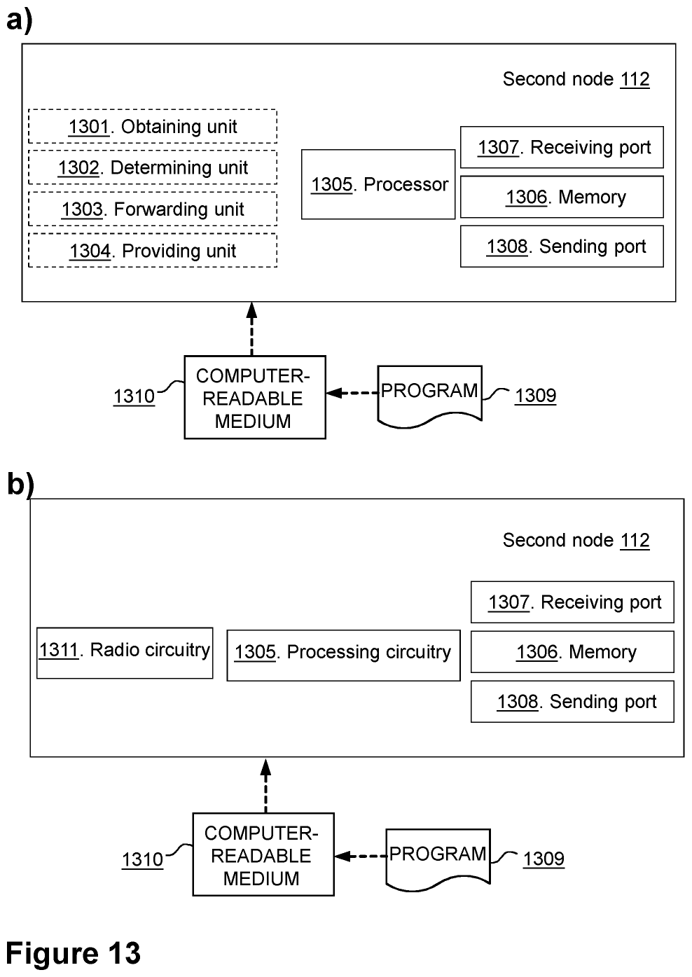

FIG. 13 depicts two different examples in panels a) and b), respectively, of the arrangement that the second node 112 may comprise to perform the method actions described above in relation to FIG. 3. In some embodiments, the second node 112 may comprise the following arrangement depicted in FIG. 13a. The second node 112 may be understood to be for handling the scaling of the network slice in the communications network 120. The second node 112 is configured to operate in the communications network 120.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the first node 111, and will thus not be repeated here. For example, the second node 112 may be an NFVO and the first node 111 may be a DAF.

The second node 112 is configured to, e.g. by means of an obtaining unit 1301 within the second node 112 configured to, obtain, from the third node 113 configured to operate in the communications network 120, the request to scale the network slice.

The second node 112 is also configured to, e.g. by means of a determining unit 1302 within the second node 112 configured to, determine whether or not to forward the request to the first node 111 configured to operate in the communications network 120. To determine is configured to be based on the amount of available resources in the communications network 120 to scale the network slice being below the threshold.

The second node 112 is also configured to, e.g. by means of a forwarding unit 1304 within the second node 112 configured to, forward the request to the first node 111, based on the result of the determining.

In some embodiments, the second node 112 may be further configured to, e.g. by means of the obtaining unit 1301 within the second node 112 configured to, obtain, from the first node 111, the indication of the response to the request configured to be forwarded. The indication is configured to be based on the cost effectiveness of the network slice.

In some embodiments, the second node 112 may be configured to, e.g. by means of a providing unit 1301 within the second node 112 configured to, provide, to the first node 111, the data regarding the provision of network slice services in the communications network 120.

The embodiments herein may be implemented through one or more processors, such as a processor 1305 in the second node 112 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1306 comprising one or more memory units. The memory 1306 is arranged to be used to store obtained information, store data, configurations, schedulings, and applications etc. to perform the methods herein when being executed in the second node 112.

In some embodiments, the second node 112 may receive information from, e.g., the first node 111, the third node 113, and/or the one or more fourth nodes 114, through a receiving port 1307. In some examples, the receiving port 1307 may be, for example, connected to one or more antennas in the second node 112. In other embodiments, the second node 112 may receive information from another structure in the communications network 120 through the receiving port 1307. Since the receiving port 1307 may be in communication with the processor 1305, the receiving port 1307 may then send the received information to the processor 1305. The receiving port 1307 may also be configured to receive other information.

The processor 1305 in the second node 112 may be further configured to transmit or send information to e.g., the first node 111, the third node 113, and/or the one or more fourth nodes 114, through a sending port 1308, which may be in communication with the processor 1305, and the memory 1306.

Those skilled in the art will also appreciate that any of the units 1301-1304 described above may refer to a combination of analog and digital circuits, and/or one or more processors configured with software and/or firmware, e.g., stored in memory, that, when executed by the one or more processors such as the processor 1305, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1301-1304 described above may be the processor 1305 of the second node 112, or an application running on such processor.

Thus, the methods according to the embodiments described herein for the second node 112 may be respectively implemented by means of a computer program 1309 product, comprising instructions, i.e., software code portions, which, when executed on at least one processor 1305, cause the at least one processor 1305 to carry out the actions described herein, as performed by the second node 112. The computer program 1309 product may be stored on a computer-readable storage medium 1310. The computer-readable storage medium 1310, having stored thereon the computer program 1309, may comprise instructions which, when executed on at least one processor 1305, cause the at least one processor 1305 to carry out the actions described herein, as performed by the second node 112. In some embodiments, the computer-readable storage medium 1310 may be a non-transitory computer-readable storage medium, such as a CD ROM disc, a memory stick, or stored in the cloud space. In other embodiments, the computer program 1309 product may be stored on a carrier containing the computer program, wherein the carrier is one of an electronic signal, optical signal, radio signal, or the computer-readable storage medium 1310, as described above.

The second node 112 may comprise an interface unit to facilitate communications between the second node 112 and other nodes or devices, e.g., the first node 111, the third node 113, and/or the one or more fourth nodes 114. In some particular examples, the interface may, for example, include a transceiver configured to transmit and receive radio signals over an air interface in accordance with a suitable standard.

In other embodiments, the second node 112 may comprise the following arrangement depicted in FIG. 13b. The second node 112 may comprise a processing circuitry 1305, e.g., one or more processors such as the processor 1305, in the second node 112 and the memory 1306. The second node 112 may also comprise a radio circuitry 1311, which may comprise e.g., the receiving port 1307 and the sending port 1308. The processing circuitry 1305 may be configured to, or operable to, perform the method actions according to FIG. 3, in a similar manner as that described in relation to FIG. 13a. The radio circuitry 1311 may be configured to set up and maintain at least a wireless connection with the first node 111, the third node 113, and/or the one or more fourth nodes 114.

Hence, embodiments herein also relate to the second node 112 operative to handle the scaling of the network slice in the communications network 120, the second node 112 being operative to operate in the communications network 120. The second node 112 may comprise the processing circuitry 1305 and the memory 1306, said memory 1306 containing instructions executable by said processing circuitry 1305, whereby the second node 112 is further operative to perform the actions described herein in relation to the second node 112, e.g., in FIG. 3.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1. A method, performed by a first node, for handling scaling of a network slice in a communications network, the first node operating in the communications network, the method comprising:
obtaining, from a second node operating in the communications network, a request to scale a network slice; and
determining whether or not to scale the network slice, the determining being based on a cost effectiveness of the network slice.

2. The method of claim 1, wherein the cost effectiveness of the network slice factors in a revenue obtained from the network slice.

3. (canceled)

4. The method of claim 1, wherein the request is received based on an amount of available resources for the network slice being below a threshold.

5. The method of claim 1, wherein the request is to scale the network slice during a time period, and wherein the method further comprises:
obtaining a predictability model of a probability of obtaining one or more further requests to scale other network slices during the time period, and wherein the determining is further based on the obtained predictability model.

6. The method of claim 5, wherein the obtaining of the predictability model is one of:
from a third node operating in the communications network, or
based on using a machine learning procedure.

7. The method claim 1, the method further comprising:
obtaining, from one or more other nodes operating in the communications network, data regarding one or more of:
revenue obtained, by the communications network, from a provision of network slice services,
provision of network slice services in the communications network,
resource availability for the provision of network slice services in the communications network, or
cost of resources for the provision of network slice services in the communications network, and
wherein the determining is further based on the obtained data.

8. (canceled)

9. A non-transitory computer-readable storage medium, having stored thereon a computer program, comprising instructions which, when executed on at least one processor, cause the at least one processor to carry out the method of claim 1.

10. A method, performed by a second node, for handling scaling of a network slice in a communications network, the second node operating in the communications network, the method comprising:
obtaining, from a third node operating in the communications network, a request to scale a network slice;
determining whether or not to forward the request to a first node operating in the communications network, the determining being based on an amount of available resources in the communications network to scale the network slice being below a threshold; and
forwarding the request to the first node, based on a result of the determining.

11. The method of claim 10, further comprising:
obtaining an indication of a response to the forwarded request from the first node, the indication being based on a cost effectiveness of the network slice.

12. The method of claim 10, the method further comprising:
providing, to the first node, data regarding provision of network slice services in the communications network.

13. (canceled)

14. A non-transitory computer-readable storage medium, having stored thereon a computer program, comprising instructions which, when executed on at least one processor, cause the at least one processor to carry out the method of claim 10.

15. A first node, for handling scaling of a network slice in a communications network, the first node being configured to operate in the communications network, the first node being further configured to:
obtain, from a second node configured to operate in the communications network, a request to scale a network slice; and
determine whether or not to scale the network slice, wherein to determine is configured to be based on a cost effectiveness of the network slice.

16. The first node of claim 15, wherein the cost effectiveness of the network slice is configured to factor in a revenue configured to be obtained from the network slice.

17. (canceled)

18. The first node of claim 15, wherein the request is configured to be received based on an amount of available resources for the network slice being below a threshold.

19. The first node of claim 15, wherein the request is to scale the network slice during a time period, and wherein the first node is further configured to:
obtain a predictability model of a probability of obtaining one or more further requests to scale other network slices during the time period, and wherein to determine is further configured to be based on the predictability model configured to be obtained.

20. The first node of claim 19, wherein to obtain the predictability model is configured to be one of:
from a third node configured to operate in the communications network, and,
based on using a machine learning procedure.

21. The first node of claim 15, the first node being further configured to:
obtain, from one or more other nodes configured to operate in the communications network, data regarding one or more of:
revenue obtained, by the communications network, from a provision of network slice services,
provision of network slice services in the communications network,
resource availability for the provision of network slice services in the communications network, or
cost of resources for the provision of network slice services in the communications network, and
wherein to determine is further configured to be based on the data configured to be obtained.

22. A second node, for handling scaling of a network slice in a communications network, the second node being configured to operate in the communications network, the second node being further configured to:
obtain, from a third node configured to operate configured to operate in the communications network, a request to scale a network slice,
determine whether or not to forward the request to a first node configured to operate in the communications network, wherein to determine is configured to be based on an amount of available resources in the communications network to scale the network slice being below a threshold, and
forward the request to the first node, based on a result of the determining.

23. The second node of claim 22, being further configured to:
obtain, from the first node, an indication of a response to the request configured to be forwarded, the indication being configured to be based on a cost effectiveness of the network slice.

24. The second node of claim 22, the second node being further configured to:
provide, to the first node, data regarding provision of network slice services in the communications network.
